(19) United States
(12) Patent Application Publication
(10) Pub. No.: US 2013/0109396 A1
(43) Pub. Date: May 2, 2013

(54) Method and Device for Data Processing in a Wireless Network

(71) Applicants: Karol Drazynski, Wroclaw (PL); Jaroslaw Lachowski, Nowy Sacz (PL); Stanislaw Strzyz, Poznan (PL)

(72) Inventors: Karol Drazynski, Wroclaw (PL); Jaroslaw Lachowski, Nowy Sacz (PL); Stanislaw Strzyz, Poznan (PL)

(21) Appl. No.: 13/696,161

(22) PCT Filed: May 6, 2010
(86) PCT No.: PCT/EP2010/056162

§ 371 Date: Jan. 3, 2013

(51) Int. Cl. H04W 36/30

(52) U.S. Cl. CPC H04W 36/30
USPC 455/444

(57) ABSTRACT

A method and a device for data processing in a wireless network are provided, said wireless network including a home base station that is at least partially deployed within a coverage area of at least one macro base station, wherein the home base station obtains an identity information of at least one macro base station; wherein the home base station determines a deterioration of a connection to a mobile terminal that is served by this home base station; and wherein the home base station conveys a context information of the mobile terminal to one macro base station identified by the identity information. Furthermore, a communication system is suggested including said device.

The invention relates to a method and to a device for data processing in a wireless network. Also, a communication system comprising at least one such device is suggested.

The solution provided relates to mobile wireless communications, e.g., 3GPP Long-Term Evolution (LTE) and LTE-Advanced (LTE-A).

Femto cells (also referred to as Home evolved NodeB, Home eNBs or HeNBs) are low power cells designed to be deployed indoors (e.g., in private buildings, shops, restaurants, etc) to offload data traffic from wide area nodes (also referred to conventional cells or Macro NBs).

The backhaul of the femto cell belongs to the user, who may limit access to his femto cell to members of a Closed Subscriber Group (CSG).

Since the output power of the macro cell differs largely from the output power of the femto cell, the user equipment (UE) may experience problems regarding radio conditions provided by the different cells, especially in case of handover (HO), because of a much smaller radio overlapping coverage area that is available for such HO.

The deployment of a femto cell parallel to macro cells has several implications. For example, as the femto cell has a significant lower output power level compared to the macro cell, usual handover procedures between femto and macro cells might fail, because radio conditions of the femto cell have much sharper and abrupt boundaries and thus smaller overlapping coverage areas compared to the handover scenario between macro cells. The problem of abrupt changing radio conditions might occur much more frequently in indoor than in outdoor scenarios, because of attenuation effects based on walls, windows, doors in case a user is moving between rooms with varying radio coverage (fast fading/shadowing).

Therefore, a mobile terminal (User Equipment, UE) that is in a connected state (RRC_CONNECTED mode) could experience radio link failures (RLFs) and thus a sudden loss of its connection in the RRC_CONNECTED mode when leaving the coverage area of its serving femto cell and entering the coverage area of a macro cell, because of said sharp boundaries of the overlaying coverage areas.

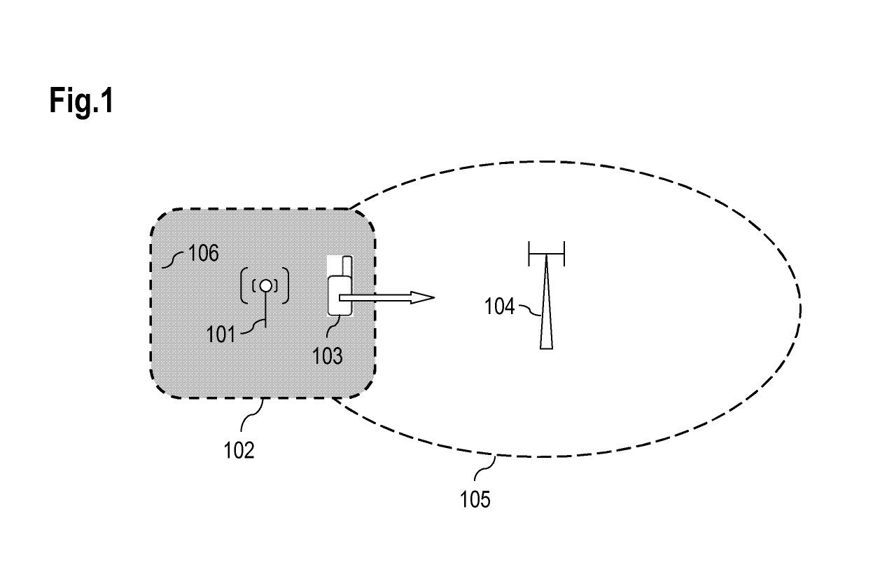

FIG. 1 shows a schematic diagram visualizing an outbound mobility scenario of a UE 103 leaving a coverage area 102 of a serving HeNB 101 and entering a coverage area 105 of a macro cell WAeNB 104. The coverage area 102 is limited to a building or a room 106. Hence, a user leaving the building or room 106 with his UE 103 in RRC_CONNECTED mode may close a door behind him and is suddenly exposed to the coverage area 105 of the macro cell WAeNB 104.

In this scenario, the UE 103 according to 3GPP TS 36.300 and TS 36.331 will experience the following scenario:

(1) The UE 103 detects an N311 out-of-sync indication from an upper layer.

(2) The UE 103 starts a timer T310.
(a) As the interference from the macro cell WAeNB 104 is too high and the signal from the HeNB 101 is too weak, the UE 103 cannot re-synchronize.

(3) After expiration of the timer T310, a RLF occurs. The UE 103 starts a timer T311 and tries to synchronize to any cell, like in RRC_IDLE mode.
(a) In this case, the cell to which the UE 103 tries to synchronize is the overlaying macro cell WAeNB 104.
(b) After synchronization, the UE 103 will send an RRCConnectionReestabilishmentRequest to the macro cell WAeNB 104.
(c) As the macro cell WAeNB 104 has no UE context stored for the UE 103, it will send an RRCConnectionReestabilishmentReject message to the UE 103.

(4) The UE 103 leaves the RRC_CONNECTED mode and the connection is dropped.

The problem to be solved is to overcome such disadvantages and in particular to provide an efficient solution for a handover from a femto cell to a macro cell.

This problem is solved according to the features of the independent claims. Further embodiments result from the depending claims.

In order to overcome this problem, a method for data processing in a wireless network comprising a home base station that is at least partially deployed within a coverage area of at least one macro base station, is suggested
wherein the home base station obtains an identity information of at least one macro base station;
wherein the home base station determines a deterioration of a connection to a mobile terminal that is served by this home base station;
wherein the home base station conveys a context information of the mobile terminal to one macro base station identified by the identity information.

Said deterioration may be an impending or an actual radio link failure. This deterioration can be used as a trigger to convey the context information of the mobile terminal to the macro base station. Hence, the context information that is required at the macro base station to avoid a connection being dropped is available when the mobile terminal requests to re-establish the connection with the macro base station.

The identity information the home base station obtains may be transmitted from the macro base station with or without a previous request from the home base station.

It is noted that the home base station may be any femto base station, home (evolved) NodeB or the like. The macro base station may be an evolved NodeB (eNB) or a wide area eNB, etc.

The wireless network may in particular be a 3GPP network, an LTE or an LTE-A network.

Thus, the solution provided efficiently enables network optimization, automated configuration and/or interference reduction in heterogeneous networks, i.e. in case of wide area macro cells and femto cells being arranged in a co-channel deployment.

In an embodiment, the identity information comprises a global cell identity (GCI) of the macro base station, which is stored with the home base station.

In another embodiment, the identity information is obtained during or after a network listening mode (NLM), in particular during a phase when the home base station is in a normal operational mode or in an RRC_IDLE mode.

In a further embodiment, the deterioration of the connection to the mobile terminal is determined in case the home base station does not receive confirmation messages within a predefined time limit.

The home base station may in particular determine a degrading connection to the mobile terminal served in case acknowledgement messages (ACK/NACK) are not received as during a good connection. Thus, the home base station may anticipate a connection loss and conveys the context information towards the macro base station.

In a next embodiment, the context information provided by the home base station is received at the macro base station and stored in particular for a predetermined period of time at the macro base station.

Hence, the context information is stored temporarily at the macro base station. The context information can be deleted after the predetermined period of time is over. Thus, unnecessary memory allocation or memory overflow can be avoided.

The predetermined period of time to store the context information with the macro base station may be based on timers T310, T311 (according to 3GPP TS 36.331, V9.2.0) and a time required for the radio access network to transfer the context information between the base stations.

It is also an embodiment that a re-establishment procedure initiated by the mobile terminal towards the macro base station is conducted by the macro base station using said context information for this mobile terminal.

Pursuant to another embodiment, the home base station obtains the identity information of the macro base station with the strongest signal received at the home base station.

The home base station may recognize its strongest macro base station via the Network Listening Mode (NLM) phase during start-up. This macro base station is the recipient of the mobile terminal's context information sent from the home base station in case of a sudden connection loss with this home base station, because this macro base station is most likely the one to which the mobile terminal is then going to send its re-establishment message (e.g., RRCConnectionReestablishment message) in case of a radio link failure (RLF).

According to an embodiment, the context information comprises at least one of the following:
a UE context;
an information element indicating the purpose of the transmission of the context information.

According to another embodiment, the information element indicates a potential re-establishment request with regard to the context information.

The purpose of such transmission being indicated by the information element can be a potential RRC Connection Reestablishment request for which the transmitted UE context can be used.

In yet another embodiment, the context information can be sent via an S1-MME interface to the macro base station.

The problem stated above is also solved by a device for data processing in a wireless network, comprising or being associated with a processing unit that is arranged
for obtaining an identity information of at least one macro base station;
for determining a deterioration of a connection to a mobile terminal;
for conveying a context information of the mobile terminal to one macro base station identified by the identity information.

According to an embodiment, the device is a home base station that is at least partially deployed within a coverage area of the at least one macro base station.

It is noted that the steps of the method stated herein may be executable on this processing unit as well.

It is further noted that said processing unit can comprise at least one, in particular several means that are arranged to execute the steps of the method described herein. The means may be logically or physically separated; in particular several logically separate means could be combined in at least one physical unit.

Said processing unit may comprise at least one of the following: a processor, a microcontroller, a hard-wired circuit, an ASIC, an FPGA, a logic device.

Furthermore, the problem stated above is solved by a communication system comprising at least one device as described herein.

Embodiments of the invention are shown and illustrated in the following figures:

FIG. 1 shows a schematic diagram visualizing an outbound mobility scenario of a UE leaving a coverage area of a serving HeNB and entering a coverage area of a macro cell WAeNB;

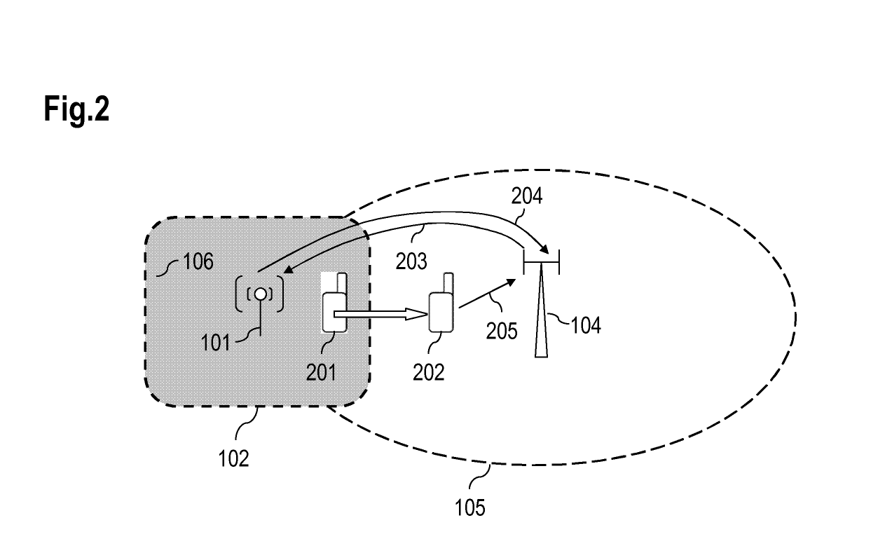

FIG. 2 shows a schematic diagram based on the scenario shown in FIG. 1, wherein a UE context is conveyed to the macro cell based on a CIG information supplied to the HeNB;

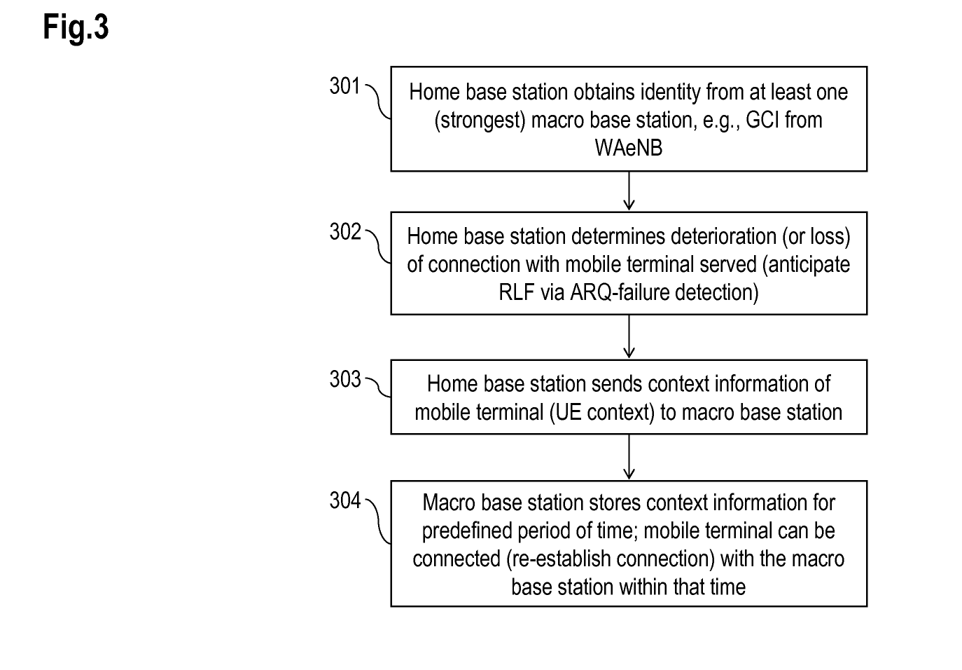

FIG. 3 shows a schematic flow chart comprising several steps to allow for a pro-active context transfer in a network architecture comprising macro cells and femto cells that are arranged in a co-channel deployment.

It is noted that the femto cell in particular comprises any home base station or sub-base station that can be deployed and used within or without a coverage area of a macro cell. The femto cell can be supplied by at least one of the following: a Home (evolved) NodeB (H(e)NB) or a home base station. The macro cell can be supplied by an according base station, e.g., an evolved NodeB (eNB) or a wide area eNB (WAeNB).

It is suggested that the HeNB stores information about the overlaying macro cell. According to 3GPP TS 22.220 (V.10.0.0), section 5.1, at the start-up of the HeNB, an authorization and configuration phase is conducted in which the HeNB reports its identity and location. This location can be based on GPS coordinates or radio-environment fingerprint information that could have been obtained during a Network Listening Mode (NLM).

The HeNB stores which WAeNB cells broadcast the strongest signal, acquires their Global Cell Identity (GCI) and stores this information. This can be done, e.g., after a provisioning phase, once the HeNB is in normal operational mode or in a RRC_IDLE mode.

The HeNB after not having received several acknowledgements (ACKs/NACKs) for HARQ processes that may be used in FDD downlink direction (according to 3GPP TS 36.213, sections 7) automatically sends the UE context to the overlaying WAeNB, which WAeNB is addressed based on the CGI acquired (as in case the handover is initiated).

The UE context received by the WAeNB indicates a potential loss of signal at the serving cell (here the HeNB). Due to its temporary nature, the WAeNB receiving the UE context may store this UE context for a predetermined period of time, e.g., a duration based on a sum of the timers T310 and T311 plus a time required for the radio access network to transfer the UE context between network elements (base stations or nodes). If the UE has not initiated an RRC reestablishment procedure towards the WAeNB within this predetermined period of time, the UE context can be deleted at the WAeNB.

FIG. 2 shows a schematic diagram based on the scenario shown in FIG. 1. References already introduced with regard to FIG. 1 refer to the same components.

As shown in FIG. 2, the UE abruptly moves from a position 201 in which it is served by the HeNB 101 to a position 202 outside the coverage area 102 in which it has to be served by a macro cell, here the WAeNB 104.

The HeNB 101 recognizes its strongest WAeNB cell 104 via the Network Listening Mode (NLM) phase during start-up (see arrow 203).

This WAeNB 104 is the recipient of the UE context sent from the HeNB (see arrow 204) in case of a connection loss or a connection deterioration with the UE, as this WAeNB 104 is most likely the one to which the UE sends a RRCConnectionReestablishment 205 message in case of a radio link failure (RLF). As the UE may rank cells in RLF mode according to radio conditions, this particular WAeNB 104 is the strongest cell for both the HeNB and the UE.

The serving HeNB 101 determines the situation in which the UE leaves its coverage area 102 and enters the WAeNB's 104 coverage area 105 without previously having sent the required measurements or without having received the HO command (RRCConnectionReconfiguration) from the serving HeNB 101. Such situation may with a significant likelihood result in a RLF.

In order to avoid that a connection is dropped, the HeNB 101 observes the amount of HARQ processes and packets that were neither acknowledged or not acknowledged by the UE for all retransmissions, which will occur in case the UE has left the coverage area 102 of the serving HeNB 101 without having commenced a properly handover to the WAeNB 104. As a maximum amount of HARQ downlink processes in FDD mode is 8 (according to 3GPP TS 36.213) and the number of retransmissions is 4, the HeNB 101 may become aware of a (pending) connection loss amount ca. 40 ms after the UE left its coverage area 102.

When the HeNB 101 recognizes the possibility of a failed outbound HO, it sends via network internal signaling over an S1-MME interface the UE context (stored during the process of NLM) to the WAeNB 104. The UE context can be accompanied by an information element indicating the purpose of such transmission being a potential RRC Connection Reestablishment request for which the transmitted UE context can be used.

On reception of this UE context, the receiving WAeNB starts an internal timer with a duration that amounts to the sum of the timer T310, the timer T311 and a time required for a network internal signaling in case of executing a handover. If the internal timer expires and if no RRCConnectionReestablishment request from this particular UE has been received, the UE context can be deleted by the WAeNB. However, If the UE has indeed lost its connection with the serving HeNB, it will send the RRCConnectionReestablishment to the WAeNB, at which now the UE context for this UE is available. Hence, the procedure for the connection reestablishment can be conducted without much delay and the connection can be maintained (no call drop occurs).

FIG. 3 shows a schematic flow chart comprising several steps to allow for a pro-active context transfer in a network architecture comprising macro cell and femto cells that are arranged in a co-channel deployment.

In a step 301, the home base station obtains an identity information from at least one macro base station, in particular from the macro base station with the strongest (broadcast) signal. The home base station may, e.g., receive the GCI from this macro base station (e.g., WAeNB). The home base station in a step 302 determines a deterioration or a loss of a connection with the mobile terminal served by this home base station. Hence, the home base station anticipates a radio link failure, e.g., by means of an ARQ-failure detection scheme. Pursuant to a step 303, the home base station sends context information (e.g., UE context) to the macro base station. The macro base station—as shown in a step 304—receives and stores this context information for a predetermined period of time. In case the mobile terminal associated with this context information initiates a re-establish connection request towards this macro base station within this predetermined period of time, the connection can be established and the connection can be maintained.

It is noted that the entities shown in FIG. 2 could be implemented by a person skilled in the art as various physical units, wherein the mobile terminal or the base stations or cells could be realized as or associated with at least one logical entity that may be deployed as hardware, program code, e.g., software and/or firmware, running on a processing unit, e.g., a computer, microcontroller, ASIC, FPGA and/or any other logic device.

The functionality described herein may be based on an existing component of a (wireless) network, which is extended by means of software and/or hardware. The base station(s) mentioned herein could also be referred to as any base station, base transceiver station or base station controller pursuant to any communication standard.

The approach described proactively conveys the UE context and thus allows avoiding RLFs. It is a fast and reliable solution in particular when HeNBs are deployed within the coverage area of WAeNBs.

It is noted that the solution presented herein can be applied to LTE and technologies other than LTE. These technologies other than LTE may in particular comprise upcoming releases or Standards. The approach can be used for FDD and TDD technologies. Also, the solution may be applied to all kinds of mobile networks, in particular providing corresponding interfaces, timers and/or elements of architecture.

### LIST OF ABBREVIATIONS

ACK Acknowledged
ARQ Automatic Repeat Request
eNB evolved NodeB (base station)
FDD Frequency Division Duplexing
GCI Global Cell Identity
HARQ Hybrid ARQ
HeNB Home evolved NodeB
HO Handover
MME Mobility Management Entity
NACK Not Acknowledged
NLM Network Listening Mode
RLF Radio Link Failure
RRC Radio Resource Control
TDD Time Division Duplexing
UE User Equipment (mobile terminal)
WAeNB Wide Area evolved NodeB

1. A method for data processing in a wireless network comprising a home base station that is deployed within a coverage area of at least one macro base station,
wherein the home base station obtains an identity information of at least one macro base station;
wherein the home base station determines a deterioration of a connection to a mobile terminal that is served by this home base station;
wherein the home base station conveys a context information of the mobile terminal to one macro base station identified by the identity information.

2. The method according to claim 1, wherein the identity information comprises a global cell identity of the macro base station, which is stored with the home base station.

3. The method according to claim 1, wherein the identity information is obtained during or after a network listening mode, in particular during a phase when the home base station is in a normal operational mode or in an RRC_IDLE mode.

4. The method according to claim 1, wherein the deterioration of the connection to the mobile terminal is determined in case the home base station does not receive confirmation messages within a predefined time limit.

5. The method according to claim 1, wherein the context information provided by the home base station is received at the macro base station and stored in particular for a predetermined period of time at the macro base station.

6. The method according to claim 1, wherein a re-establishment procedure initiated by the mobile terminal towards the macro base station is con-ducted by the macro base station using said context information for this mobile terminal.

7. The method according to claim 1, wherein the home base station obtains the identity information of the macro base station with the strongest signal received at the home base station.

8. The method according to claim 1, wherein the context information comprises at least one of the following:
a UE context;
an information element indicating the purpose of the transmission of the context information.

9. The method according to claim 8, wherein the information element indicates a potential re-establishment request with regard to the context information.

10. The method according to claim 1, wherein the context information can be sent via an S1-MME interface to the macro base station.

11. A device for data processing in a wireless network comprising a processing unit that is arranged
for obtaining an identity information of at least one macro base station;
for determining a deterioration of a connection to a mobile terminal;
for conveying a context information of the mobile terminal to one macro base station identified by the identity information.

12. The device according to claim 11, wherein the device is a home base station that is deployed within a coverage area of the at least one macro base station.

13. A communication system comprising at least one device according to claim 11.
